(19) United States
(12) Patent Application Publication
(10) Pub. No.: US 2010/0205444 A1
(43) Pub. Date: Aug. 12, 2010

(54) Software Program for Encrypting and Decrypting, Digital Media; Photograph and Video and encoding an expiration date in them.

(76) Inventor: Jatinkumar Harjivan Mehta, Ann Arbor, MI (US)

Correspondence Address: Jatinkumar Mehta, 1911 Lindsay Lane, Ann Arbor, MI, 48104, US

(21) Appl. No.: 12/370,281

(22) Filed: Feb. 12, 2009

(51) Int. Cl. H04L 9/32

(52) U.S. Cl. 713/176

(57) ABSTRACT

The digital media, photograph and video encryption and decryption software will encrypt the photograph or video and a provision is provided to put an expiration date on the photograph or video, after the expiration date the Software program will give a message saying the photograph or video has expired and not decrypt the photograph or video for viewing. The encryption key can be stored on an online web account, which can be modified by the user and lets the user; change the expiration date of a particular photograph or video. All the information; encryption key, expiration date; will be stored inside the encrypted media, photograph or video as a digital watermark or in a separate file based on user preference.

### BACKGROUND OF THE INVENTION

As the number of digital camera's increase all over the world, more and more people are sharing and sending their photographs and videos to each other. The digital media, photograph and video can be copied many times without losing any quality or resolution, this creates a problem; because now from just one photograph or video; we can have millions of copies on the Internet and recipients personal computers; without the original media owner's knowledge. Also if the Original photograph or video Owner wanted the recipients; to not see their photographs or videos; anymore there is no means of doing so. In other words once the photographs or videos are sent to the recipients the original media owner's loose all control over them.

The photograph's and video's posted on millions of websites all over the world can also be copied and stored without any knowledge of the Photograph's owner's. Internet usage has increased a lot all over the world in the past years and will keep increasing in the future. This is creating a urgent need for a software program which can encrypt/decrypt the users photographs and videos and give them some form of control over them.

### BRIEF DESCRIPTION OF THE DRAWINGS

FIG. 1 is a flow diagram illustrating the processing of the user's digital media.

### DETAILED DESCRIPTION

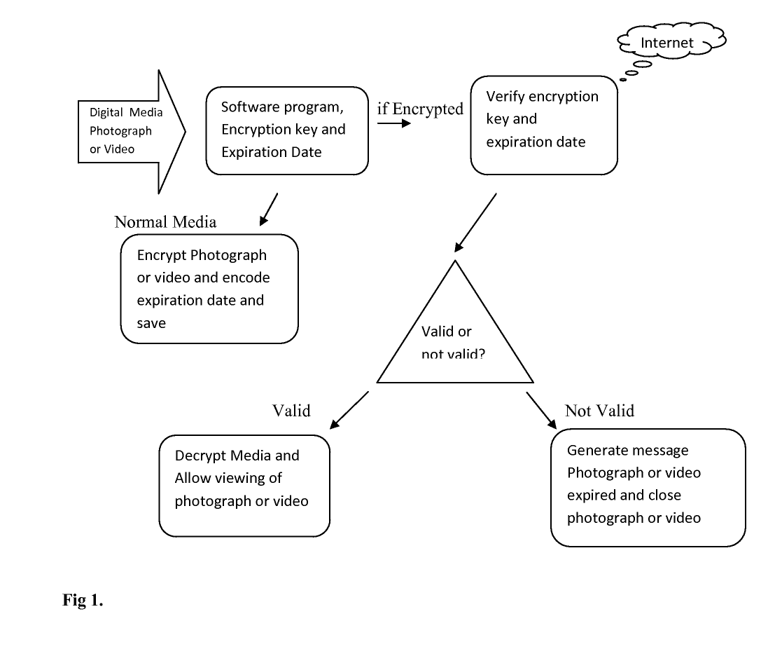

Our software program will encrypt/decrypt the Digital media, photograph and video; all formats; for example Jpeg, Gif, Bmp, Mpeg, wmv etc. . . . ; and will provide a separate Encryption key for each photograph/video or share the same key for a group of photograph's/video's; as shown in FIG. 1. Then encode an expiration date provided by the user. When the expiration date is reached the software program will give a message saying that the photograph/video has expired and ask the user to delete the photograph/video and not decrypt the photograph/video for viewing. The Encryption keys can be stored on an Online Web account accessible by the user. The user can go to their Web account and modify the encryption keys settings; changing the Expiration date for the photograph's/Video's associated with the encryption key. The users can also have a trusted users list and they can have special privileges set forth by the user.

The software program will have means of verifying the encryption keys with the user's Web account. The encrypted photograph/Video will only be decrypted and made viewable in the software program mentioned. If the user tries to open the encrypted photograph/video in any other program, the photograph/video either will not be viewable or not open. The Digital Media encryption and decryption software can be installed on a computer, mobile device/pocket PC, or net book/laptop computers irrespective of their native operating system. This software can also be incorporated on Internet Browsers or chat engines as a plug-in application; allowing the user to post their encrypted photographs/video's on the internet (web sites) Chat rooms. so when someone tries to save a copy of their photograph/video, they will be saving an encrypted version of the photograph/video. Encrypting the photograph means changing the photograph pixel by pixel so when it is viewed in any photograph viewing software it appears completely distorted and nothing like the original. Encrypting the video means changing the video frame by frame so when it is opened in any other video software it will appear distorted or not open at all. Once the video is encrypted the audio inside the video will also get encrypted. The idea is that the unintended recipient cannot see your photograph or video.

The program will not allow Print screen or any other print functions for the photographs, it will also not allow any record functions for videos. The recipients when viewing the digital media with a valid encryption key will not have any means of printing or storing or recording the digital media in its unencrypted format.

The video formats such as mpeg, wmv etc. both standard and high definition will be supported in the program, but we want to make it clear that this program is not for DVD files and has nothing to do with DVD encryption and authoring. The Software program will be completely different then the commercially available DVD authoring and encrypting software. The software program is intended for personal use by individuals and organizations seeking more security and exclusivity; for their clients, employees or friends.

What is claimed is:

1. The method and Program of encrypting and decrypting a Digital media, photograph and video with an encryption key and encoding an expiration date in them; using a custom software program.

2. The encryption keys mentioned in claim 1, can be stored and modified by the user on their Web account, allowing them means to extend the expiration date of their Photographs/Videos.

3. The method mentioned in claim 1 is not confined to any Computer operating systems or platform and can be incorporated as a Plug-in application in Internet browsers and chat engines like Windows Internet Explorer, Messenger, AOL, Yahoo, Mozilla, Firefox, Opera, . . . etc. The Digital Media encryption and decryption software can be installed on a computer, mobile device/pocket PC, or net book/laptop computers irrespective of their native operating system.
